(19) United States
(12) Patent Application Publication
(10) Pub. No.: US 2004/0216686 A1
(43) Pub. Date: Nov. 4, 2004

(54) Cat box decorative screen with interchangeable panels

(76) Inventor: Jerri Mitchell, Oak Brook, IL (US)

Correspondence Address: JoAnne M. Denison, Suite 1608, 212 W. Washington Blvd., Chicago, IL, 60606-3487, US

(21) Appl. No.: 10/427,673

(22) Filed: May 1, 2003

(51) Int. Cl. A01K 29/00

(52) U.S. Cl. 119/165

(57) ABSTRACT

The present invention consists of an improved screen device for camouflaging a cut litter box or bedding area having two upstanding side support panels, one upstanding end support panel, with all of the support panels being hingedly interconnected. Further, each support panel is provided on its exterior surface with a standard attachment means, such as miniature hook/loop fastening elements, a plurality of bolts or screws, and/or channel hardware which is intended to interconnect to the following elements which are located on the interior of corresponding removable decorative panels: corresponding miniature hook/loop fastening elements, keyhole slots, or an inverted J-shaped hook. The present inventive device may further be provided with a pair of hingedly connecting floor panels so that when the user desires to set up the screen, the side panels are put in place in rectangular alignment, the floor panels are swung down into position, and then highly decorative exterior panels, such as hand painted wood panels or Japanese rice screen are attached to the exterior of the support panels, creating a highly decorative and versatile screening system.

### FIELD OF THE INVENTION

The present invention relates to the field of screening devices for cat and kitten litter pan screens, and more particularly those with interchangeable exterior decorative panels.

### BACKGROUND OF THE INVENTION

Currently, in the marketplace, there are available a wide variety of cat litter box covers that are designed to enclose the mess and smell of a litter box, which is disagreeable to cat owners. Oftentimes, a cat litter box must be placed in the area of a home wherein the cot litter box is visible to the home owner and to visitors. Over recent years, home owners have purchased more valuable and expensive items for their pets such as hand painted pet beds and furniture. In a living room in particular, home owners greatly desire to have each item of furniture to be highly decorative and uniquely made. Although cat owners have ingeniously devised various means to contain the mess and smell of a cat litter box, most of these items are industrial in nature and are made from inexpensive plastics and card board which is often considered unsightly for use in a living room area.

In reviewing the prior art, there are a number of cat box litter covers that are primarily decorative in nature and mimic building structures. For example, the following U.S. Design Patents resemble decorative houses: U.S. Des. Pat. No. 425,674 issued to D. Dykens resembles a gingerbread house; U.S. Des. Pat. No. 347,304 issued to A. Hellem resembles a modern home with clean, simple designs; U.S. Des. Pat. No. 319,115 issued to R. White resembles a country home; U.S. Des. Pat. No. 230,285 issued to J. Dilley resembles a Swiss Chalet; and, U.S. Des. Pat. No. 298,672 issued to W. Herbst resembles a clapboard home with shutters and cedar shake roof. U.S. Des. Pat. No. 276,752 issued to S. Kinzie and U.S. Des. Pat. No. 228,558 issued to R. Brickel both resemble barns. U.S. Pat. No. 5,337,700 issued to B. Toft even resembles a castle. However, none of these building structure type cat litter box covers can be changed or altered as the user desires.

Two U.S. Design patents disclose collapsible structures intended to enclose and conceal a cat litter box are U.S. Des. Pat. No. 245,191; U.S. Des. Pat. No. 311,795. Although it might be convenient to collapse and store a litter box, nonetheless, it would not appear that either of these structures have features which will allow the owner to change the decorative features of these items.

There are also disclosed in the prior U.S. patents which illustrate cat litter box chambers which may be collapsed by the owner: U.S. Pat No. 5,865,140 issued to S. McGivern; U.S. Pat. No. 3,890,930 issued to M. Clark; U.S. Pat. No. 4,792,082 issued to G. Williamson, U.S. Pat. No. 5,027,748 issued to R. Wolak; U.S. Pat. No. 5,046,457 issued to R. Ashcroft; U.S. Pat. No. 5,465,686; U.S. Pat. No. 5,730,085 issued to C. Santoiemmo; and, U.S. Pat. No. 5,014,649 issued to M. Taft. None of these devices allow the user to change the decorative features of the exterior of the device.

In U.S. Pat. No. 3,581,708 issued to J. Beck is disclosed a cat litter box which is shaped like a house with a gabled roof and has a front door flop. U.S. Pat. No. 4,348,982 issued to J. Selby discloses the use of a cat litter chamber intended to more fully prevent the escape of waste smells. This particular device is not only disposable, but also has filters disposed in apertures in the sidewalls of the device to prevent smells from escaping therefrom.

U.S. Pat. No. 4,181,095 issued to M. Sylogye discloses the use of folding screen panels which are hinged so that the screen may be easily collapsed. However, the screen device is not provided with a floor member to contain the litter mess which may be kick out of the cat box. U.S. Pat. No. 4,858,561 issued to H. Springer discloses the use of a portable and collapsible pet enclosure which is zippered at one end to allow the litter box to be changed. U.S. Pat. No. 5,566,640 issued to J. Krumrei shows the use of a maze type of litter box container which is capable of creating an isolated or dead air space to create an air lock chamber to prevent odors from escaping therefrom. U.S. Pat. No. 5,582,133 issued to K. Zimmerlin discloses the use of a cat litter pan enclosure with a smaller pan within a larger tub to prevent a cat from spraying onto adjoining walls and drapes when it urinates. And finally, U.S. Pat. No. 5,329,879 issued to R. Walton discloses the use of a cat litter box suitable for use with cats and kittens alike because it is provided with a small ramp at the entrance of the device for the kitten to climb up onto to enter the device. A plastic line may be held in place by an upper portion which clamps onto a lower pan.

Thus, nowhere in the prior is seen a decorative cat litter box enclosure wherein the user may change the appearance of the device as desired.

### SUMMARY OF THE INVENTION

The present invention consists of an improved litter box enclosure having at least three upstanding side walls, a floor or base portion and secured to each side wall, means for attaching decorative panels thereto. The means for attaching decorative panels can comprise either miniature hook and loop fasteners, hooks, pegs or snap means, or any other commonly used mounting means found in the relevant art of attachment devices. The device can be made from any material which can contain urine from escaping onto a floor surface, such as rigid plastic or other copolymer, or it can even be made from stainless steel. Common steel and other steel alloys may not be able to survive without significant degradation, the rigors of standing urine on their surfaces. Common steel would tend to rust.

The decorative panels which may be attached to the device may range from simple Japanese rice screens made from black pointed pine and rice paper, to elaborately painted wood panels which can blend in with any decor, from art deco, to traditional, modern, Asian, etc. In any case, since the decorative panels are removable, the user can change the room decor and purchase new decorative panels to match the new room decor. Or, as the panels wear or get dirty through use, the owner can simply purchase additional panels yet keep the interior frame or sidewall structure because this will not need to be changed.

In one preferred embodiment, the improved cat litter decorative panel device may be made with simple hinged frame members that are provided with a variety of attachment means such as miniature hook and loop fasteners, hooks, pegs or snap means, or any other commonly used mounting means found in the relevant art of attachment devices. Such a device would only be useful in situations where the cats using the device do not tend to spray on adjoining surfaces. The interior of the device can also be provided with a separate line which can be removably secured to hooks or clamps for holding up the liner, in case the cat does spray on the interior of the device.

As an additional feature of the device, the panels may be readily folded or take apart so that the device may be collapsed for easy transportation from room to room, or to clean the interior frame members or side wall members.

In an additional preferred embodiment of the present invention, the panels are slidingly removably engaged into a lower platform or base which is provided with three slots which allow the decorative panels to be retained in an upstanding manner. This device may be made from steel, plastic or wood. In the case of a wooden design, the interior may be provided with a plurality of hooks which are intended to removably retain a plastic liner to prevent accumulation of fecal matter which could damage the device.

### OBJECTS OF THE INVENTION

Thus, it is one primary object of the present invention to provide a cat litter box enclosure or chamber having at least three upstanding sidewalls which are provided on their exterior walls with at least one means for attaching a decorative panel thereto.

It is yet an additional primary object of the present invention to provide a cat litter box enclosure or chamber having at least three upstanding frame sidewall members which are provided on their exterior surface with at least one means for attaching a decorative panel thereto.

It is still a further primary object of the present invention to provide a cat litter box enclosure or chamber having at least three upstanding fame sidewall members or sidewalls wherein the attachment means on their exterior surfaces consists of commonly used mounting means found in the marketplace, such as miniature hook and loop fasteners, hooks, pegs or snap means or any other commonly used mounting means.

Yet a further primary object of the present invention to provide a cat litter box enclosure or chamber having at least three upstanding fame sidewall members or sidewalls wherein the decorative panels which may be attached to the exterior of the sidewall members or sidewalls may consist of a wide variety of decorative panels, such as Japanese rice paper, original works of art, hand painted wood panels and the like.

Additionally it is primary object of the present invention to provide a cat litter box enclosure or chamber having at least three upstanding fame sidewall members or sidewalls wherein the side walls or frame members which are not exposed may be made from a corrosion resistant, highly cleanable material such as plastic or stainless steel.

It is yet an additional primary object of the present invention to provide a cat litter box enclosure or chamber having at least three upstanding frame sidewall members and a base with three corresponding slots which the sidewall members may be removably secured within.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a perspective view of one embodiment of the present invention showing it in actual use with decorative hand painted wood panels attached thereto.

FIG. 2 is a top plan view of one embodiment of the present invention showing the form of an interior with solid side walls and hinged walls with separable hinge pins.

FIG. 3 is a top plan view of one embodiment of the present invention showing the interior detail of a decorative frame panel member and a variety of standard attachment elements and removable hinge pins.

FIG. 4 is a top plan view of one embodiment of the present invention showing the exterior of a solid support panel with attached fastening elements.

FIG. 5 is a top plan view of one embodiment of the present invention having a frame type support panel with plastic liner attachment means.

FIG. 6 is a perspective exploded view of an embodiment of the present invention having three removable decorative panels which may be removably secured within three slots in a base member or platform.

### DETAILED DESCRIPTION OF THE DRAWINGS

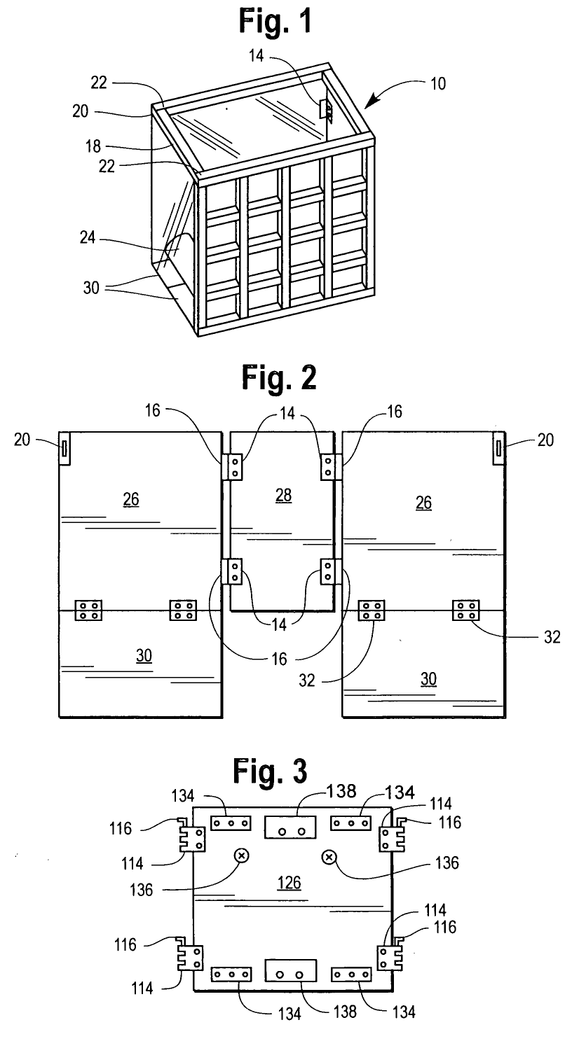

Shown now in FIG. 1 is improved decorative cat litter box screen 10 which has a removable decorative panel 12 on the front of the device, as well as matching decorative panels on the end and rear of the device. In this particular instance, decorative panel 12 consists of a Japanese rice panel screen which is a very aesthetically pleasing design. Of course, other types of decorative panels may be utilized in this invention. And, where the device is used up against a wall, there is no need to purchase a rear decorative panel for the device. Two overlapping floor panels 30 make up the bottom of the device and provide rigidity and stability thereto. For additional stability, a support bar 18 is suspended along the top opening side of the present invention. This support bar 18 rests upon two side pins 20 which are attached to the interior sides of the decorative cat litter box screen 10. The support bar 18 is provided with two pin apertures 22 at either end so that the support bar 18 may firmly seat upon the side pins 20. A standard litter pan 24 may be placed in the open end of the device. Hinges 14 are utilized so that the device might be easily taken apart and/or collapsed by the user of the device.

It is believed that an appropriate dimension for the height of the front, rear and side panels would be at least 8″ and at most 36″ to ensure that the cat litter box is well hidden. Although a top or cover is not shown in the drawings herein, it is well known in the prior art that a top or cover is preferred by some cat owners to keep down dust from flowing outside the cat box when in use. If a cover or top is desire, it may be a simple planar topp may be used, or a pitched top or other configuration may be utilized. However, some cat owners do not prefer the use of a top or cover because it traps litter dust in the air in the closed container, and it may cause some cats and kittens to suffer from lung afflictions, including cat allergies, asthma and coughing.

FIG. 2 shows the present invention improved decorative cat litter box screen 10 in top plan view as it appears when taken apart and laid open flat. In this particular view, side support panels 26 are hingedly connected to floor panels 30 with floor hinges 32 and side pins 16 which are open at their tops. End support panel 28 is disposed between side support panels 26 and is provided with a hinges 14 which are provided with a bore which accommodates side pins 16. In such a manner, side panels 26 may be completely disconnected from end panel 28 for easy storage of improved decorative cat litter box screen 10. Or, when the device is initially set up, hinges 14 are merely slid onto and over side pins 16, and then floor panels 30 are swung down to the floor and the side support panels are moved into a box formation so that the support bar 18 may be placed upon side pins 20. In such a manner, improved decorative cat litter box screen 10 is readily constructed by the user.

Of course, it is believed that rigid materials which are resistant to corrosion should be used for the side support panels 26, end support panel 28 and floor panel 30 to prevent these elements from being degraded from cat urine and feces which con easily corrode many materials. For this reason, it is believed that materials such as stainless or coated steels or rigid plastics should be used for the items. All of the hinges and pins should also be made from anti-corrosive materials, which are known in the art, as well as any fastening elements used to secure the hinges to the support panels, such as screws, bolts and the like. In the case where the support and floor panels are made from metal, the hinges may be simply spot welded to the support and floor panels.

FIG. 3 shows a representative exterior surface of a support panel 126 which has a wide variety of means by which a decorative panel may be attached to the exterior of a support panel. In this particular figure, each of the following commonly utilized fastening means may be used: miniature hook/loop fasteners 134, standard fasteners 136 consisting of bolts or screws, or an elongate channel forming fastener 138 may be used. Also shown in this figure is an alternate method of using hinges 114 with removable hinge pins 116 to provide a means by which the user may easily take down or set up the device. The hinge pins 116 shown are L-shaped so that they may be easily grabbed when the user decides to remove the pins to break down the device.

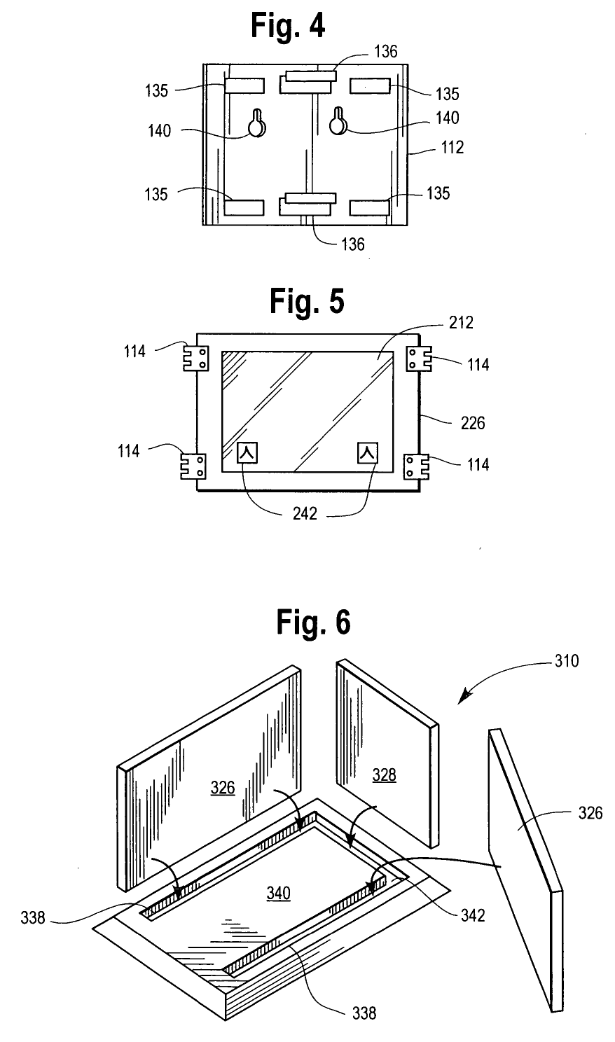

FIG. 4 show the back side of a representative interior side of a decorative 112 which has a wide variety of corresponding means by which a decorative panel is attached to the exterior of a support panel. Shown on decorative panel 112 are the following corresponding attachment means: miniature hook/loop fasteners 135, inverted J shaped hanger which attaches readily to channel forming fastener 138 of FIG. 3, and, keyhole slots 140 which are adapted to fit and secure a standard fastening element such as the head of a bolt or screw 136 shown in FIG. 3.

Finally, FIG. 5 shows yet an additional preferred embodiment of the present invention, improved decorative cat litter box screen, wherein the support panels are substituted for side support frame members, which have less material. In this instance, the rear of decorative panel 212 shows through the center of side support frame member 226. Hinges 214 are also provided to secure additional panels together. Also provided are a plurality of hooks with sharp tips 242 which can easily accommodate a standard plastic liner to protect the interior of the improved decorative cat litter box screen. These hooks with sharp tips 242 can easily pierce any standard plastic liner so that the liner is readily secured thereto. It is anticipated that the hooks with sharp tips 242 are made from plastic so that they do not injure either the owner or the cat, and they may also be secured to any position on the interior of the improved decorative cat litter box screen with a foam double backed adhesive tape in any position that is convenient for the user. Foam double backed adhesive tape is well known and readily available in the field of adhesive tapes and removable securement devices.

Figure shows an exploded perspective view of an alternative embodiment of the present invention in which a thickened base member 340 is provided with opposing deep slots 338 and end slot 342. Opposing sidewalls 326 may easily and removably placed into deep side slots 338, while end sidewall 328 is easily and removably placed into end deep slot 342. In such a manner, an efficient and easy to use collapsible cat box chamber 310 has been created. Base member 340 is preferably deep and heavy to retain the sidewalls, and may range from 0.7″ to 2.0″ or more in depth. The slots are preferably 0.5″ to 0.75″ wide to accommodate thick heavy decorative panels.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. An improved screen to surround an animal's litter box having two upstanding side support panels; an end support panel adjoining each of the side support panels; at least one decorative side panel and at least one decorative end panel; and, an exterior surface on each of the support panels which has means to affix a decorative panels thereto, wherein each of the side and end support panels is substantially 6″ to 36″ in height.

2. The improved screen of claim 1 wherein at least two hinge means are provided and are used to join the end support panel to the two side panels.

3. The improved screen of claim 1 wherein the means to affix a decorative panel to a side panel comprises at least one miniature hook and loop fastener attached to the exterior of the side support panel and one corresponding miniature hook and loop fastener attached to the decorative panel.

4. The improved screen of claim 1 wherein the means to affix a decorative panel to a side panel comprises at least one bolt or screw with a bolt or screw head attached to the exterior of the side support panel and one keyhole slot in the decorative panel such that a user may merely hang the decorative panel onto the side support panel by placing the keyhole slot over and onto the bolt or screw head.

5. The improved screen of claim 1 wherein the means to affix a decorative panel to a side panel comprises at least one channel element attached to the exterior of the side support panel and one corresponding inverted J-shaped flange member attached to the decorative panel such that he user may merely hang the decorative panel onto the side support panel by placing the inverted J-shaped flange member over and onto the channel element.

6. The improved screen of claim 2 wherein the at least two hinge means comprise two standard hinges with removable hinge pins.

7. The improved screen of claim 1 further having two floor panels each hingedly attached to a side support panel.

8. The improved screen of claim 1 further having an interior surface for each for the support panels and at least one J-shaped hook attached to each interior surface for the purposed of installing and supporting a plastic liner within the improved screen device.

9. The improved screen of claim 1 wherein each support panel is made from one or more of the following materials: stainless steel, a rigid plastic or other copolymer or a coated steel which is corrosion resistant.

10. An improved screen to surround an animal's litter box having two upstanding side support panels each with a lower edge, an end support panel also having a lower edge which end support panel adjoins each of the side support panels; a substantially heavy, thick base member which is provided with at least two opposing side slots adapted to fit and receive the two upstanding side panels at their lower edge and at least one end slot which is adapted to fit and receive the side support panel at its lower edge.
